(19) United States
(12) Patent Application Publication
(10) Pub. No.: US 2009/0083237 A1
(43) Pub. Date: Mar. 26, 2009

(54) Method, Apparatus and Computer Program Product for Providing a Visual Search Interface

(75) Inventors: Natasha Gelfand, Sunnyvale, CA (US); Wei-Chao Chen, Los Altos, CA (US); Radek Grzeszczuk, Menlo Park, CA (US); Yingen Xiong, Mountain View, CA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 11/858,356

(22) Filed: Sep. 20, 2007

(51) Int. Cl. G06F 17/30

(52) U.S. Cl. 707/4; 707/E17.008

(57) ABSTRACT

An apparatus for providing a visual search interface may include a processing element configured to receive indications of an image including an object, receive location information indicative of a location associated with a user providing the indications of the image, and enable performance of a visual search based on the location information and features of the image to identify candidate search results by comparing the image to source images stored in association with a location within a predetermined distance from the location associated with the user.

### TECHNOLOGICAL FIELD

Embodiments of the present invention relate generally to content retrieval technology and, more particularly, relate to a method, apparatus and computer program product for providing a visual search interface.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users. One area in which there is a demand to increase the ease of information transfer and convenience to users relates to provision of information retrieval in networks. For example, information such as audio, video, image content, text, data, etc., may be made available for retrieval between different entities using various communication networks. Accordingly, devices associated with each of the different entities may be placed in communication with each other to locate and affect a transfer of the information. In particular, mechanisms have been developed to enable devices such as mobile terminals to conduct searches for information or content related to a particular query or keyword.

Text based searches typically involve the use of a search engine that is configured to retrieve results based on query terms inputted by a user. However, due to linguistic challenges such as words having multiple meanings, the quality of search results may not be consistently high. Additionally, data sources searched may not have information on a particular topic for which the search is being conducted.

Given the above described problems associated with text searches, other search types have been popularized. Recently, content based searches are becoming more popular with respect to visual searching. In certain situations, for example, when a user wishes to retrieve image content from a particular location such as a database, the user may wish to review images based on their content. In this regard, for example, the user may wish to review images of cats, animals, cars, etc. Although some mechanisms have been provided by which metadata may be associated with content items to enable a search for content based on the metadata, insertion of such metadata may be time consuming. Additionally, a user may wish to find content in a database in which the use of metadata is incomplete or unreliable. Accordingly, content based image retrieval solutions have been developed which utilize, for example, a classifier such as a support vector machine (SVM) to classify content based on its relevance with respect to a particular query. Thus, for example, if a user desires to search a database for images of cats, a query image could be provided of a cat and the SVM could search through the database and provide images to the user based on their relevance with respect to the features of the query image. Feedback mechanisms have also been provided to enable a user to provide feedback for further definition of a classification border between relevance and irrelevance with respect to search results.

Visual search functions such as, for example, mobile visual search functions performed on a mobile terminal, may leverage large visual databases using image matching to compare a query or input image with images in the visual databases. Image matching may tell how close the input image is to images in the visual database. The top matches (e.g., the most relevant images) may then be presented to the user by being visualized on a display of the mobile terminal. Context information associated with the image may then be provided. Accordingly, simply by pointing a camera mounted on the mobile terminal toward a particular object, the user can potentially get context information associated with the particular object.

However, a problem associated with visual searches may be that the large visual databases that are needed for employment of such search techniques may require relatively large numbers of source images for feature comparisons. As such, a typical search database can only provide adequate coverage for searches that fall within particular areas in which the search database has a sufficiently large number of source images. Yet another problem that may be associated with searches conducted on a mobile terminal relates to difficulties associated with using the user interface of the mobile terminal. In this regard, it is typical for different text characters to be associated with a single key, thereby sometimes making the task of character entry seem laborious since multiple key pushes may be required for the entry of each character. Thus, entries associated with providing a text based query or entries limiting a location associated with the search may be difficult to provide thereby reducing user enjoyment and/or the utility of search services.

Accordingly, it may be advantageous to provide an improved mechanism for providing a search interface capable of curing at least some of the problems described above.

### BRIEF SUMMARY

A method, apparatus and computer program product are therefore provided to provide an improved visual search interface for use in a visual search system. In particular, a method, apparatus and computer program product are provided that provide for the use of location information and visual search characteristics to conduct a visual based search in a more efficient and flexible manner. In this regard, for example, visual based searching may be enhanced by the incorporation of location information and databases having content used for the conduct of searches may be updated based on user selections. As such, updated databases may grow the number of source images associated with given points of interest and may alternatively provide for the addition of new source images corresponding to existing or new points of interest. Accordingly, the efficiency of image content retrieval may be increased and content management, navigation, tourism, and entertainment functions for electronic devices such as mobile terminals may be improved.

In one exemplary embodiment, a method of providing an improved visual search interface is provided. The method may include receiving indications of an image including an object, receiving location information indicative of a location associated with a device providing the indications of the image, and enabling performance of a visual search based on the location information and features of the image to identify candidate search results by comparing the image to source images stored in association with a location within a predetermined distance from the location associated with the device.

In another exemplary embodiment, a computer program product for providing an improved visual search interface is provided. The computer program product includes at least one computer-readable storage medium having computer-readable program code portions stored therein. The computer-readable program code portions include first, second and third executable portions. The first executable portion is for receiving indications of an image including an object. The second executable portion is for receiving location information indicative of a location associated with a device providing the indications of the image. The third executable portion is for enabling performance of a visual search based on the location information and features of the image to identify candidate search results by comparing the image to source images stored in association with a location within a predetermined distance from the location associated with the device.

In another exemplary embodiment, an apparatus for providing an improved visual search interface is provided. The apparatus may include a processing element configured to receive indications of an image including an object, receive location information indicative of a location associated with a device providing the indications of the image, and enable performance of a visual search based on the location information and features of the image to identify candidate search results by comparing the image to source images stored in association with a location within a predetermined distance from the location associated with the device.

In another exemplary embodiment, an apparatus for providing an improved visual search interface is provided. The apparatus includes means for receiving indications of an image including an object, means for receiving location information indicative of a location associated with a device providing the indications of the image and means for enabling performance of a visual search based on the location information and features of the image to identify candidate search results by comparing the image to source images stored in association with a location within a predetermined distance from the location associated with the device.

Embodiments of the invention may provide a method, apparatus and computer program product for employment in devices to enhance content retrieval such as by visual searching. As a result, for example, mobile terminals and other electronic devices may benefit from an ability to perform content retrieval in an efficient manner and provide results to the user in an intelligible and useful manner with a reduced reliance upon text entry.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a schematic block diagram of a mobile terminal according to an exemplary embodiment of the present invention;

FIG. 2 is a schematic block diagram of a wireless communications system according to an exemplary embodiment of the present invention;

FIG. 3 illustrates a block diagram of an apparatus for providing a visual search interface according to an exemplary embodiment of the present invention; and

FIG. 4 is a flowchart according to an exemplary method for providing an improved visual search interface according to an exemplary embodiment of the present invention.

### DETAILED DESCRIPTION

Embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

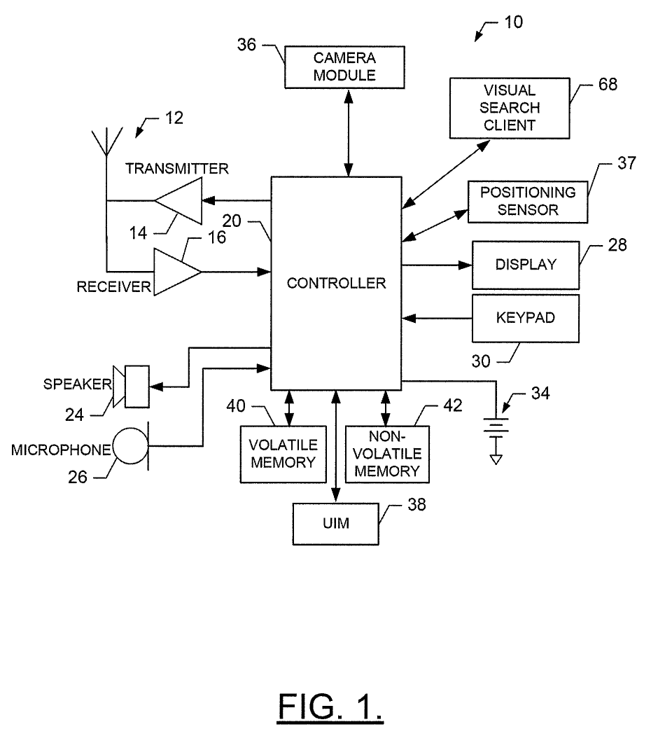

FIG. 1 illustrates a block diagram of a mobile terminal 10 that would benefit from embodiments of the present invention. It should be understood, however, that a mobile telephone as illustrated and hereinafter described is merely illustrative of one type of mobile terminal that would benefit from embodiments of the present invention and, therefore, should not be taken to limit the scope of embodiments of the present invention. While one embodiment of the mobile terminal 10 is illustrated and will be hereinafter described for purposes of example, other types of mobile terminals, such as portable digital assistants (PDAs), pagers, mobile computers, mobile televisions, gaming devices, laptop computers, cameras, video recorders, GPS devices and other types of voice and text communications systems, can readily employ embodiments of the present invention. Furthermore, devices that are not mobile may also readily employ embodiments of the present invention.

The system and method of embodiments of the present invention will be primarily described below in conjunction with mobile communications applications. However, it should be understood that the system and method of embodiments of the present invention can be utilized in conjunction with a variety of other applications, both in the mobile communications industries and outside of the mobile communications industries.

The mobile terminal 10 includes an antenna 12 (or multiple antennae) in operable communication with a transmitter 14 and a receiver 16. The mobile terminal 10 further includes an apparatus, such as a controller 20 or other processing element, that provides signals to and receives signals from the transmitter 14 and receiver 16, respectively. The signals include signaling information in accordance with the air interface standard of the applicable cellular system, and also user speech, received data and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second, third and/or fourth-generation communication protocols or the like. For example, the mobile terminal 10 may be capable of operating in accordance with second-generation (2G) wireless communication protocols IS-136 (time division multiple access (TDMA)), GSM (global system for mobile communication), and IS-95 (code division multiple access (CDMA)), or with third-generation (3G) wireless communication protocols, such as Universal Mobile Telecommunications System (UMTS), CDMA2000, wideband CDMA (WCDMA) and time division-synchronous CDMA (TD-SCDMA), with fourth-generation (4G) wireless communication protocols or the like.

It is understood that the apparatus such as the controller 20 includes circuitry desirable for implementing audio and logic functions of the mobile terminal 10. For example, the controller 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The controller 20 thus may also include the functionality to convolutionally encode and interleave message and data prior to modulation and transmission. The controller 20 can additionally include an internal voice coder, and may include an internal data modem. Further, the controller 20 may include functionality to operate one or more software programs, which may be stored in memory. For example, the controller 20 may be capable of operating a connectivity program, such as a conventional Web browser. The connectivity program may then allow the mobile terminal 10 to transmit and receive Web content, such as location-based content and/or other web page content, according to a Wireless Application Protocol (WAP), Hypertext Transfer Protocol (HTTP) and/or the like, for example.

The mobile terminal 10 may also comprise a user interface including an output device such as a conventional earphone or speaker 24, a microphone 26, a display 28, and a user input interface, all of which are coupled to the controller 20. The user input interface, which allows the mobile terminal 10 to receive data, may include any of a number of devices allowing the mobile terminal 10 to receive data, such as a keypad 30, a touch display (not shown) or other input device. In embodiments including the keypad 30, the keypad 30 may include the conventional numeric (0-9) and related keys (#, *), and other hard and/or soft keys used for operating the mobile terminal 10. Alternatively, the keypad 30 may include a conventional QWERTY keypad arrangement. The keypad 30 may also include various soft keys with associated functions. In addition, or alternatively, the mobile terminal 10 may include an interface device such as a joystick or other user input interface. The mobile terminal 10 further includes a battery 34, such as a vibrating battery pack, for powering various circuits that are required to operate the mobile terminal 10, as well as optionally providing mechanical vibration as a detectable output.

In an exemplary embodiment, the mobile terminal 10 includes a media capturing element, such as a camera, video and/or audio module, in communication with the controller 20. The media capturing element may be any means for capturing an image, video and/or audio for storage, display or transmission. For example, in an exemplary embodiment in which the media capturing element is a camera module 36, the camera module 36 may include a digital camera capable of forming a digital image file from a captured image. As such, the camera module 36 includes all hardware, such as a lens or other optical component(s), and software necessary for creating a digital image file from a captured image. Alternatively, the camera module 36 may include only the hardware needed to view an image, while a memory device of the mobile terminal 10 stores instructions for execution by the controller 20 in the form of software necessary to create a digital image file from a captured image. In an exemplary embodiment, the camera module 36 may further include a processing element such as a co-processor which assists the controller 20 in processing image data and an encoder and/or decoder for compressing and/or decompressing image data. The encoder and/or decoder may encode and/or decode according to, for example, a joint photographic experts group (JPEG) standard or other format. Additionally, or alternatively, the camera module 36 may include one or more views such as, for example, a first person camera view and a third person map view.

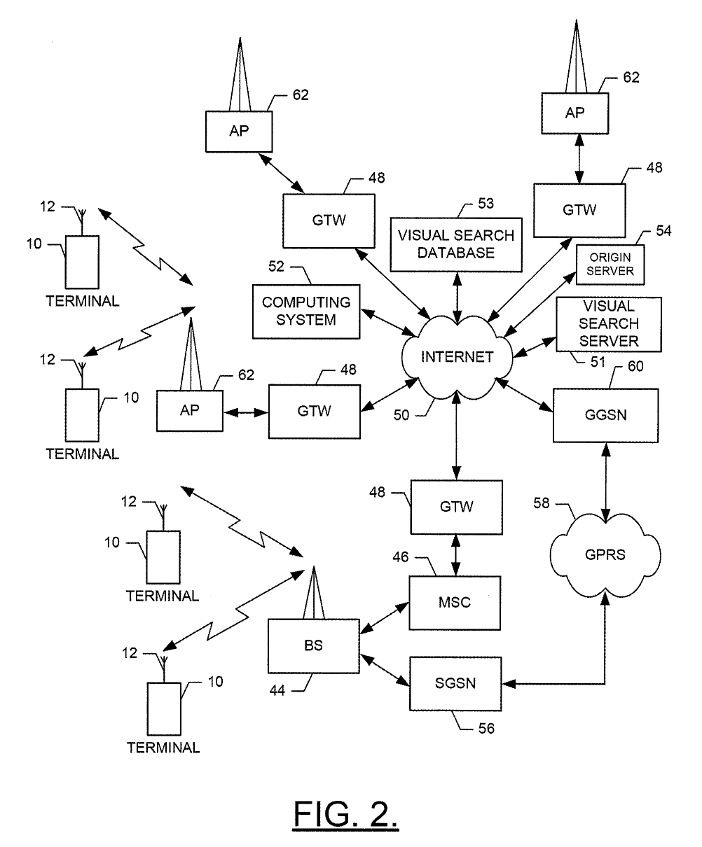

The mobile terminal 10 may further include a positioning sensor 37 such as, for example, a global positioning system (GPS) module in communication with the controller 20. The positioning sensor 37 may be any means, device or circuitry for locating the position of the mobile terminal 10. Additionally, the positioning sensor 37 may be any means for locating the position of a point-of-interest (POI), in images captured by the camera module 36, such as for example, shops, bookstores, restaurants, coffee shops, department stores and other businesses and the like. As such, points-of-interest as used herein may include any entity of interest to a user, such as products and other objects and the like. The positioning sensor 37 may include all hardware for locating the position of a mobile terminal or a POI in an image. Alternatively or additionally, the positioning sensor 37 may utilize a memory device of the mobile terminal 10 to store instructions for execution by the controller 20 in the form of software necessary to determine the position of the mobile terminal or an image of a POI. Although the positioning sensor 37 of this example may be a GPS module, the positioning sensor 37 may include or otherwise alternatively be embodied as, for example, an assisted global positioning system (Assisted-GPS) sensor, or a positioning client, which may be in communication with a network device to receive and/or transmit information for use in determining a position of the mobile terminal 10. In this regard, the position of the mobile terminal 10 may be determined by GPS, as described above, cell ID, signal triangulation, or other mechanisms as well. In one exemplary embodiment, the positioning sensor 37 includes a pedometer or inertial sensor. As such, the positioning sensor 37 may be capable of determining a location of the mobile terminal 10, such as, for example, longitudinal and latitudinal directions of the mobile terminal 10, or a position relative to a reference point such as a destination or start point. Information from the positioning sensor 37 may then be communicated to a memory of the mobile terminal 10 or to another memory device to be stored as a position history or location information. Additionally, the positioning sensor 37 may be capable of utilizing the controller 20 to transmit/receive, via the transmitter 14/receiver 16, locational information such as the position of the mobile terminal 10 and a position of one or more POIs to a server such as, for example, a visual search server 51 and/or a visual search database 53 (see FIG. 2), described more fully below. 100281 The mobile terminal 10 may also include a visual search client 68 (e.g., a unified mobile visual search/mapping client). The visual search client 68 may be any means, device or circuitry embodied in hardware, software, or a combination of hardware and software that is capable of communication with the visual search server 51 and/or the visual search database 53 (see FIG. 2) to process a query (e.g., an image or video clip) received from the camera module 36 for providing results including images having a degree of similarity to the query. For example, the visual search client 68 may be configured for recognizing (either through conducting a visual search based on the query image for similar images within the visual search database 53 or through communicating the query image (raw or compressed), or features of the query image to the visual search server 51 for conducting the visual search and receiving results) objects and/or points-of-interest when the mobile terminal 10 is pointed at the objects and/or POIs or when the objects and/or POIs are in the line of sight of the camera module 36 or when the objects and/or POIs are captured in an image by the camera module 36.

The mobile terminal 10 may further include a user identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which can be embedded and/or may be removable. The non-volatile memory 42 can additionally or alternatively comprise an electrically erasable programmable read only memory (EEPROM), flash memory or the like, such as that available from the SanDisk Corporation of Sunnyvale, Calif., or Lexar Media Inc. of Fremont, Calif. The memories can store any of a number of pieces of information, and data, used by the mobile terminal 10 to implement the functions of the mobile terminal 10. For example, the memories can include an identifier, such as an international mobile equipment identification (IMEI) code, capable of uniquely identifying the mobile terminal 10.

FIG. 2 is a schematic block diagram of a wireless communications system according to an exemplary embodiment of the present invention. Referring now to FIG. 2, an illustration of one type of system that would benefit from embodiments of the present invention is provided. The system includes a plurality of network devices. As shown, one or more mobile terminals 10 may each include an antenna 12 for transmitting signals to and for receiving signals from a base site or base station (BS) 44. The base station 44 may be a part of one or more cellular or mobile networks each of which includes elements required to operate the network, such as a mobile switching center (MSC) 46. As well known to those skilled in the art, the mobile network may also be referred to as a Base Station/MSC/Interworking function (BMI). In operation, the MSC 46 is capable of routing calls to and from the mobile terminal 10 when the mobile terminal 10 is making and receiving calls. The MSC 46 can also provide a connection to landline trunks when the mobile terminal 10 is involved in a call. In addition, the MSC 46 can be capable of controlling the forwarding of messages to and from the mobile terminal 10, and can also control the forwarding of messages for the mobile terminal 10 to and from a messaging center. It should be noted that although the MSC 46 is shown in the system of FIG. 2, the MSC 46 is merely an exemplary network device and embodiments of the present invention are not limited to use in a network employing an MSC.

The MSC 46 can be coupled to a data network, such as a local area network (LAN), a metropolitan area network (MAN), and/or a wide area network (WAN). The MSC 46 can be directly coupled to the data network. In one typical embodiment, however, the MSC 46 is coupled to a gateway device (GTW) 48, and the GTW 48 is coupled to a WAN, such as the Internet 50. In turn, devices such as processing elements (e.g., personal computers, server computers or the like) can be coupled to the mobile terminal 10 via the Internet 50. For example, as explained below, the processing elements can include one or more processing elements associated with a computing system 52, origin server 54, the visual search server 51, the visual search database 53, and/or the like, as described below.

The BS 44 can also be coupled to a signaling GPRS (General Packet Radio Service) support node (SGSN) 56. As known to those skilled in the art, the SGSN 56 is typically capable of performing functions similar to the MSC 46 for packet switched services. The SGSN 56, like the MSC 46, can be coupled to a data network, such as the Internet 50. The SGSN 56 can be directly coupled to the data network. In a more typical embodiment, however, the SGSN 56 is coupled to a packet-switched core network, such as a GPRS core network 58. The packet-switched core network is then coupled to another GTW 48, such as a GTW GPRS support node (GGSN) 60, and the GGSN 60 is coupled to the Internet 50. In addition to the GGSN 60, the packet-switched core network can also be coupled to a GTW 48. Also, the GGSN 60 can be coupled to a messaging center. In this regard, the GGSN 60 and the SGSN 56, like the MSC 46, may be capable of controlling the forwarding of messages, such as MMS messages. The GGSN 60 and SGSN 56 may also be capable of controlling the forwarding of messages for the mobile terminal 10 to and from the messaging center.

In addition, by coupling the SGSN 56 to the GPRS core network 58 and the GGSN 60, devices such as a computing system 52 and/or origin server 54 may be coupled to the mobile terminal 10 via the Internet 50, SGSN 56 and GGSN 60. In this regard, devices such as the computing system 52 and/or origin server 54 may communicate with the mobile terminal 10 across the SGSN 56, GPRS core network 58 and the GGSN 60. By directly or indirectly connecting mobile terminals 10 and the other devices (e.g., computing system 52, origin server 54, visual search server 51, visual search database 53, etc.) to the Internet 50, the mobile terminals 10 may communicate with the other devices and with one another, such as according to the Hypertext Transfer Protocol (HTTP) and/or the like, to thereby carry out various functions of the mobile terminals 10.

Although not every element of every possible mobile network is shown and described herein, it should be appreciated that the mobile terminal 10 may be coupled to one or more of any of a number of different networks through the BS 44. In this regard, the network(s) may be capable of supporting communication in accordance with any one or more of a number of first-generation (1G), second-generation (2G), 2.5G, third-generation (3G), 3.9G, fourth-generation (4G) mobile communication protocols or the like. For example, one or more of the network(s) can be capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. Further, for example, one or more of the network(s) can be capable of supporting communication in accordance with 3G wireless communication protocols such as a UMTS network employing WCDMA radio access technology. Some narrow-band analog mobile phone service (NAMPS), as well as total access communication system (TACS), network(s) may also benefit from embodiments of the present invention, as should dual or higher mode mobile stations (e.g., digital/analog or TDMA/CDMA/analog phones).

The mobile terminal 10 can further be coupled to one or more wireless access points (APs) 62. The APs 62 may comprise access points configured to communicate with the mobile terminal 10 in accordance with techniques such as, for example, radio frequency (RF), Bluetooth (BT), infrared (IrDA) or any of a number of different wireless networking techniques, including wireless LAN (WLAN) techniques such as IEEE 802.11 (e.g., 802.11a, 802.11b, 802.11g, 802.11n, etc.), world interoperability for microwave access (WiMAX) techniques such as IEEE 802.16, and/or ultra wideband (UWB) techniques such as IEEE 802.15 and/or the like. The APs 62 may be coupled to the Internet 50. Like with the MSC 46, the APs 62 can be directly coupled to the Internet 50. In one embodiment, however, the APs 62 are indirectly coupled to the Internet 50 via a GTW 48. Furthermore, in one embodiment, the BS 44 may be considered as another AP 62. As will be appreciated, by directly or indirectly connecting the mobile terminals 10 and the computing system 52, the origin server 54, and/or any of a number of other devices, to the Internet 50, the mobile terminals 10 can communicate with one another, the computing system, etc., to thereby carry out various functions of the mobile terminals 10, such as to transmit data, content or the like to, and/or receive content, data or the like from, the computing system 52. As used herein, the terms “data,” “content,” “information” and similar terms may be used interchangeably to refer to data capable of being transmitted, received and/or stored in accordance with embodiments of the present invention. Thus, use of any such terms should not be taken to limit the spirit and scope of embodiments of the present invention.

As will be appreciated, by directly or indirectly connecting the mobile terminals 10 and the computing system 52, the origin server 54, the visual search server 51, the visual search database 53 and/or any of a number of other devices, to the Internet 50, the mobile terminals 10 can communicate with one another, the computing system, 52, the origin server 54, the visual search server 51, the visual search database 53, etc., to thereby carry out various functions of the mobile terminals 10, such as to transmit data, content or the like to, and/or receive content, data or the like from, the computing system 52, the origin server 54, the visual search server 51, and/or the visual search database 53, etc. The visual search server 51, for example, may be embodied as one or more other servers such as, for example, a visual map server that may provide map data relating to a geographical area of one or more mobile terminals 10 or one or more points-of-interest (POI) or a POI server that may store data regarding the geographic location of one or more POI and may store data pertaining to various points-of-interest including but not limited to location of a POI, category of a POI, (e.g., coffee shops or restaurants, sporting venue, concerts, etc.) product information relative to a POI, and the like. Accordingly, for example, the mobile terminal 10 may capture an image or video clip which may be transmitted as a query to the visual search server 51 for use in comparison with images or video clips stored in the visual search database 53. As such, the visual search server 51 may perform comparisons with images or video clips taken by the camera module 36 and determine whether or to what degree these images or video clips are similar to images or video clips stored in the visual search database 53.

Although not shown in FIG. 2, in addition to or in lieu of coupling the mobile terminal 10 to computing systems 52 and/or the visual search server 51 and visual search database 53 across the Internet 50, the mobile terminal 10 and computing system 52 and/or the visual search server 51 and visual search database 53 may be coupled to one another and communicate in accordance with, for example, RF, BT, IrDA or any of a number of different wireline or wireless communication techniques, including LAN, WLAN, WiMAX, UWB techniques and/or the like. One or more of the computing system 52, the visual search server 51 and visual search database 53 can additionally, or alternatively, include a removable memory capable of storing content, which can thereafter be transferred to the mobile terminal 10. Further, the mobile terminal 10 can be coupled to one or more electronic devices, such as printers, digital projectors and/or other multimedia capturing, producing and/or storing devices (e.g., other terminals). Like with the computing system 52, the visual search server 51 and the visual search database 53, the mobile terminal 10 may be configured to communicate with the portable electronic devices in accordance with techniques such as, for example, RF, BT, IrDA or any of a number of different wireline or wireless communication techniques, including universal serial bus (USB), LAN, WLAN, WiMAX, UWB techniques and/or the like.

In an exemplary embodiment, content such as image content, location information and/or POI information may be communicated over the system of FIG. 2 between a mobile terminal, which may be similar to the mobile terminal 10 of FIG. 1 and a network device of the system of FIG. 2, or between mobile terminals. For example, a database may store the content at a network device of the system of FIG. 2, and the mobile terminal 10 may desire to search the content for a particular type of content. However, it should be understood that the system of FIG. 2 need not be employed for communication between mobile terminals or between a network device and the mobile terminal, but rather FIG. 2 is merely provided for purposes of example. Furthermore, it should be understood that embodiments of the present invention may be resident on a communication device such as the mobile terminal 10, or may be resident on a network device or other device accessible to the communication device.

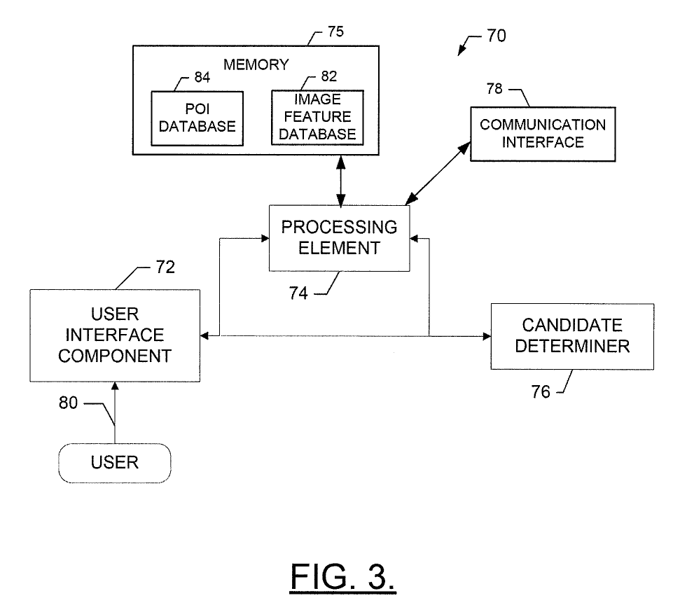

FIG. 3 illustrates a block diagram of an apparatus for providing an improved visual search interface for use in a search system according to an exemplary embodiment of the present invention. The apparatus of FIG. 3 will be described, for purposes of example, in connection with the mobile terminal 10 of FIG. 1. However, it should be noted that the apparatus of FIG. 3 may also be employed in connection with a variety of other devices, both mobile and fixed, and therefore, embodiments of the present invention should not be limited to application on devices such as the mobile terminal 10 of FIG. 1. In this regard, embodiments may also be practiced in the context of a client-server relationship in which the client (e.g., the visual search client 68) issues a query to the server (e.g., the visual search server 51) and the server practices embodiments of the present invention and communicates results to the client. Alternatively, some functions described below may be practiced on the client, while others are practiced on the server. Decisions with regard to what processes are performed at which device may typically be made in consideration of balancing processing costs and communication bandwidth capabilities. It should also be noted, that while FIG. 3 illustrates one example of a configuration of an apparatus for providing an improved visual search interface, numerous other configurations may also be used to implement embodiments of the present invention.

Referring now to FIG. 3, a search apparatus 70 for providing an improved visual search interface is provided. In exemplary embodiments, the search apparatus 70 may be embodied at either one or both of the mobile terminal 10 (e.g., as the visual search client 68) and the visual search server 51 (or another network device). In other words, portions of the search apparatus 70 may be resident at the mobile terminal 10 while other portions are resident at the visual search server 51. Alternatively, the search apparatus 70 may be resident entirely on the mobile terminal 10 and/or the visual search server 51. The search apparatus 70 may include a user interface component 72, a processing element 74, a memory 75, a candidate determiner 76 and a communication interface 78. In an exemplary embodiment, the processing element 74 could be embodied as the controller 20 of the mobile terminal 10 of FIG. 1 or as a processor or controller of the visual search server 51. However, alternatively, the processing element 74 could be a processing element of a different device. Processing elements as described herein may be embodied in many ways. For example, the processing element 74 may be embodied as a processor, a coprocessor, a controller or various other processing means, circuits or devices including integrated circuits such as, for example, an ASIC (application specific integrated circuit). In an exemplary embodiment, the user interface component 72, the candidate determiner 76 and/or the communication interface 78 may be controlled by or otherwise embodied as the processing element 74.

The communication interface 78 may be embodied as any device, circuitry or means embodied in either hardware, software, or a combination of hardware and software that is configured to receive and/or transmit data from/to a network and/or any other device or module in communication with an apparatus (e.g., the search apparatus 70) that is employing the communication interface 78. In this regard, the communication interface 78 may include, for example, an antenna and supporting hardware and/or software for enabling communications via a wireless communication network. Additionally or alternatively, the communication interface 78 may be a mechanism by which location information and/or indications of an image (e.g. a query) may be communicated to the processing element 74 and/or the candidate determiner 76. Accordingly, in an exemplary embodiment, the communication interface 78 may be in communication with a device such as the camera module 36 (either directly or indirectly via the mobile terminal 10) for receiving the indications of the image and/or with a device such as the positioning sensor 37 for receiving location information identifying a position or location of the mobile terminal 10.

The user interface component 72 may be any device, means or circuitry embodied in either hardware, software, or a combination of hardware and software that is capable of receiving user inputs and/or providing an output to the user. The user interface component 72 may include, for example, a keyboard, keypad, function keys, mouse, scrolling device, touch screen, or any other mechanism by which a user may interface with the search apparatus 70. The user interface component 72 may also include a display, speaker or other output mechanism for providing an output to the user. In an exemplary embodiment, rather than including a device for actually receiving the user input and/or providing the user output, the user interface component 72 could be in communication with a device for actually receiving the user input and/or providing the user output. As such, the user interface component 72 may be configured to receive indications of the user input from an input device and/or provide messages for communication to an output device.

In an exemplary embodiment, the user interface component 72 may be configured to receive indications of a query 80 from the user. The query 80 may be, for example, an image containing content providing a basis for a content based retrieval operation. In this regard, the query 80 may be an image (e.g., a query image) acquired by any method. However, in an exemplary embodiment, the query 80 may be an image that was acquired via the camera module 36, for example, via the taking of a picture. In other words, the query 80 could be a newly created image that the user has captured at the camera module 36. In alternative embodiments, the query 80 could include a raw image, a compressed image (e.g., a JPEG image), or features extracted from an image. Any of the raw image, compressed image or features from an image could form the basis for a search among the contents of the memory 75.

The user interface component 72 may also be configured to receive input or feedback from the user with regard to selection of a correct candidate result from a list of candidate results and/or an input to establish an association between an image associated with the query 80 and a particular location or POI as described in greater detail below. The user interface component 72 may also be configured to receive text entry, user preferences, or the like.

The memory 75 (which may be a volatile or nonvolatile memory) may include an image feature database 82 and/or a POI database 84. In this regard, for example, the image feature database 82 may include source images or features of source images for comparison to a captured image (e.g., an image captured by the camera module 36) or features of the captured image. The POI database 84 may include various different POIs associated with a particular location and/or objects that may appear in an image. As indicated above, the memory 75 could be remotely located from the mobile terminal 10 or partially or entirely located within the mobile terminal 10. As such, the memory 75 may be memory onboard the mobile terminal 10 or accessible to the mobile terminal 10 that may have capabilities similar to those described above with respect to the visual search database 53 and/or the visual search server 51. Alternatively, the memory 75 could be embodied as the visual search database 53 and/or the visual search server 51. In an exemplary embodiment, at least some of the images stored in the memory 75 may be source images associated with a particular location that may be used for comparison to query images. As such, for example, a location tag or other indicator identifying a location associated with a corresponding image may be stored in association with the corresponding image.

The candidate determiner 76 may be any device, circuit or means embodied in either hardware, software, or a combination of hardware and software that is configured to determine candidate results in response to a search corresponding to the indications of an image (e.g., the query 80). In this regard, the candidate results may include candidate POIs that are determined based on both location information and visual search results. In other words, the candidate determiner 76 may include an algorithm, device or other means for performing content based searching with respect to indications of an image received via the query 80 (e.g., a raw image, a compressed image, and/or features of an image) by comparing the indications of the image, which may include an object or features of the object, to other images in the memory 75 (e.g., the image feature database 82) and by comparing the location of the mobile terminal 10 to POIs within a predetermined distance of the location of the mobile terminal 10 (e.g., from the POI database 84). As such, the candidate determiner 76 may be configured to receive information from the communication interface 78 regarding indications of the image and location information. In an exemplary embodiment, the candidate determiner 76 may be configured to only compare the query 80 to images (or features) that have been stored (e.g., in the memory 75) in association with objects that are within a predetermined distance (e.g., based on location information associated with the stored images (e.g., the location tag)) of the user in order to limit the set of images used for comparison to only those that are likely to be viable candidates due to distance considerations.

Accordingly, in an exemplary embodiment, in response to receipt of indications of an image such as via the query 80 (e.g., a raw image, a compressed image, and/or features of an image) in which the image includes an object, the processing element 74 (e.g., via control of the candidate determiner 76) may be configured to receive location information indicative of a location associated with a user providing the indications of the image and perform or otherwise enable performance of a visual search based on the location information and features of the image. As a result the processing element 74 may identify candidate search results including at least one candidate POI by comparing the image to source images stored in association with a location within a predetermined distance from the location associated with the user. In this regard, for example, images stored in a local (or remote) database (e.g., the memory 75 or one of the servers of FIG. 2) that are associated with the location of the user may be searched to find a matching image with respect to features of the image. As such, by limiting the number of images searched to only images that are likely, due to location considerations, to be associated with the captured image, search time and processing resource consumption may be reduced.

The processing element 74 may be further configured to receive an input from a user making an association between a particular POI and the image in response to the identified candidate search results. In an exemplary embodiment, the processing element 74 may query a local (or remote) database for a matching image to the image. The matching image may be selected based on having similar features to the image indicative of the inclusion of the object in the matching image.

In an embodiment in which the matching image is found, the processing element 74 may be further configured to provide a POI associated with the matching image as the particular POI. Accordingly, in response to receiving the input from the user making the association of the image with the particular POI, the remote (and/or the local) database may be updated based on the association to thereby enable future searches to consider the association just made by the user for ranking purposes (e.g., ranking the candidate search results according to which is the most likely POI based on prior associations). Notably, if there is a matching image returned, but the user does not believe the matching image corresponds to the image or is otherwise not associated with the particular POI, the user may select an option to delete a previously existing association from the local and/or remote database.

In an embodiment, in which the matching image is not found, the processing element 74 may be configured to provide a plurality of potential choices or points of interest as the candidate search results. The plurality of choices or points of interest may be determined based on POI data, Internet yellow pages, pictures from the Internet, etc. Alternatively or additionally the plurality of choices or points of interest may be determined based on the location associated with the image. For example, a location based search for proximate points of interest to the location associated with the image may be conducted automatically whenever no matching image is found. In such a case, ranking of the results may not be performed. Alternatively, if ranking is performed, such ranking may be made on the basis of distance of the proximate points of interest to the location associated with the image. If the user selects one of the plurality of POIs as the correct choice, then the local and/or remote database may be updated to reflect the association made by the selection.

Accordingly, if the matching image is found, the corresponding POI may be provided as either the top or only candidate in the candidate search results and the selection of the corresponding POI may be used for future ranking operations. This may be considered an image matching scenario. However, if the matching image is not found, the selection of a corresponding POI by the user from a list of POIs in the candidate search results (or manual entry of a correct POI) may result in the forming of an association between the image and the POI and thus, for future search operations, the image may be a source image for comparison to other images for use in finding a corresponding POI. This may be considered a training mode, in which the search apparatus 70 is trained to enable the addition of further source images for use in connection with future searching operations. In an exemplary embodiment, for any given POI, multiple images (and potentially multiple different objects) may correspond to the POI and may be source images for use in future search operations since multiple images may share a common location tag and/or may also be associated with a given POI.

In an exemplary embodiment, if the matching image is found and/or if the user selects the particular POI from the candidate search results, more detailed information associated with the particular POI may be provided from either the local or remote database. The more detailed information may include address, telephone number, email address, a corresponding web page, a description of goods or services provided, a map of the local area, or numerous other informational items. The user may also be provided (e.g., via the user interface 72) with a display of actions that may be performed with respect to the particular POI. For example, options related to initiating actions such as a web search, making a call, sending an email, etc., may be provided to the user for selection (e.g., via the user interface 72). Upon selection of an action, a corresponding external application (e.g., a web browser, web based search engine, etc.) may be launched.

In another exemplary embodiment, a subset of information corresponding to the location associated with the user may be pre-fetched by the search apparatus 70. In this regard, for example, images, features of images, POI data, or other information associated with the location associated with the user may be pre-fetched to reduce latency in the event of a subsequent query. Various events or schemes could be used to trigger pre-fetching. For example, changing location could trigger pre-fetching a subset of information associated with the new location. Alternatively, user preferences could define particular times, events, locations, etc., that trigger pre-fetching. Furthermore, the subset of information pre-fetched may be determined based on user preferences and/or search history.

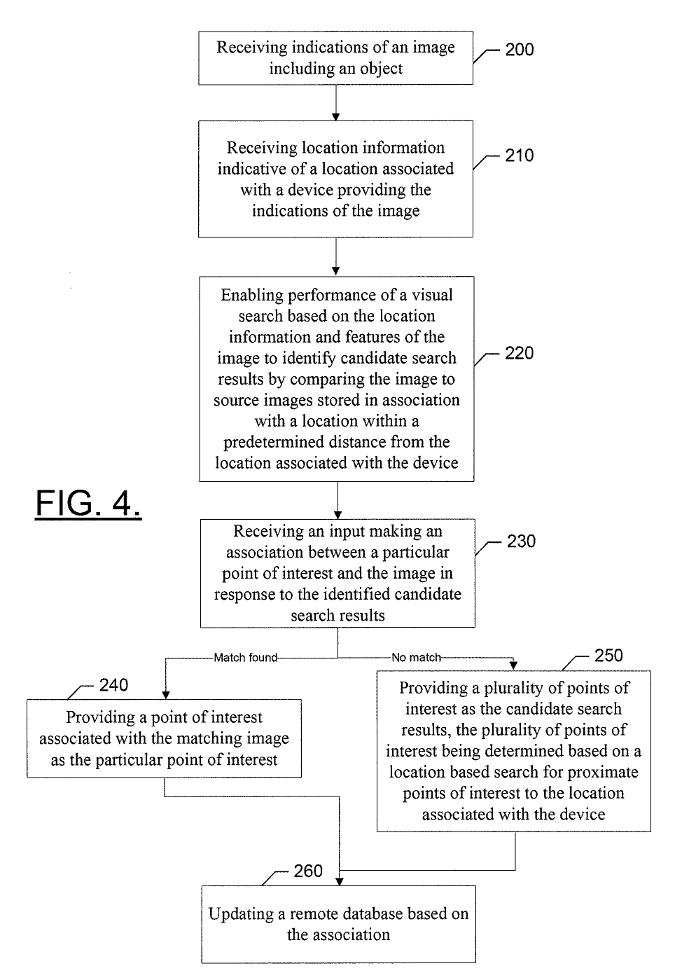

FIG. 4 is a flowchart of a method and program product according to exemplary embodiments of the invention. It will be understood that each block or step of the flowcharts, and combinations of blocks in the flowcharts, can be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of a mobile terminal or server and executed by a built-in processor in a mobile terminal or server. As will be appreciated, any such computer program instructions may be loaded onto a computer or other programmable apparatus (i.e., hardware) to produce a machine, such that the instructions which execute on the computer or other programmable apparatus create means for implementing the functions specified in the flowcharts block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowcharts block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowcharts block(s) or step(s).

Accordingly, blocks or steps of the flowcharts support combinations of means for performing the specified functions, combinations of steps for performing the specified functions and program instruction means for performing the specified functions. It will also be understood that one or more blocks or steps of the flowcharts, and combinations of blocks or steps in the flowcharts, can be implemented by special purpose hardware-based computer systems which perform the specified functions or steps, or combinations of special purpose hardware and computer instructions.

In this regard, one embodiment of a method for providing an improved visual search interface as illustrated, for example, in FIG. 4, may include receiving indications of an image including an object at operation 200. At operation 210, location information indicative of a location associated with a device or user providing the indications of the image may be received. Performance of a visual search may be enabled based on the location information and features of the image to identify candidate search results by comparing the image to source images stored in association with a location within a predetermined distance from the location associated with the device or user at operation 220. The visual search may be performed by querying a local database for a matching image to the image, in which the matching image includes the object.

In an exemplary embodiment, the method may further operation 230 of receiving an input from the device making an association between a particular point of interest and the image in response to the identified candidate search results. Other optional operations may also be included in the method subsequent to determining whether there is a matching image. In this regard, for example, if the matching image is found, the method may further include providing a point of interest associated with the matching image as the particular point of interest at operation 240. Alternatively, if the matching image is not found, the method may further include providing a plurality of points of interest as the candidate search results at operation 250. The plurality of points of interest may be determined based on a location based search for proximate points of interest to the location associated with the device or user. In response to receiving the input from the user, a database may be updated based on the association at operation 260.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method comprising:
receiving indications of an image including an object;
receiving location information indicative of a location associated with a device providing the indications of the image; and
enabling performance of a visual search based on the location information and features of the image to identify candidate search results by comparing the image to source images stored in association with a location within a predetermined distance from the location associated with the device.

2. The method of claim 1, further comprising receiving an input making an association between a particular point of interest and the image in response to the identified candidate search results.

3. The method of claim 2, wherein enabling the performance of the visual search comprises querying a local database for a matching image to the image, in which the matching image includes the object.

4. The method of claim 3, wherein, if the matching image is found, the method further comprises providing a point of interest associated with the matching image as the particular point of interest and, in response to receiving the input from the user, updating a remote database based on the association.

5. The method of claim 3, wherein, if the matching image is not found, the method further comprises providing a plurality of points of interest as the candidate search results, the plurality of points of interest being determined based on a location based search for proximate points of interest to the location associated with the device.

6. The method of claim 5, further comprising updating a remote database based on the association made responsive to receipt of the input for use in future visual searches.

7. The method of claim 2, further comprising receiving a selection of an action to be performed with respect to the particular point of interest and launching an external application based on the selected action.

8. The method of claim 1, further comprising pre-fetching a subset of information corresponding to the location associated with the device.

9. A computer program product comprising at least one computer-readable storage medium having computer-readable program code portions stored therein, the computer-readable program code portions comprising:
a first executable portion for receiving indications of an image including an object;
a second executable portion for receiving location information indicative of a location associated with a device providing the indications of the image; and
a third executable portion for enabling performance of a visual search based on the location information and features of the image to identify candidate search results by comparing the image to source images stored in association with a location within a predetermined distance from the location associated with the device.

10. The computer program product of claim 9, further comprising a fourth executable portion for receiving an input making an association between a particular point of interest and the image in response to the identified candidate search results.

11. The computer program product of claim 10, wherein the third executable portion includes instructions for querying a local database for a matching image to the image, in which the matching image includes the object.

12. The computer program product of claim 11, wherein, if the matching image is found, the computer program product further comprises a fifth executable portion for providing a point of interest associated with the matching image as the particular point of interest and, in response to receiving the input from the user, updating a remote database based on the association.

13. The computer program product of claim 11, wherein, if the matching image is not found, the computer program product further comprises a fifth executable portion for providing a plurality of points of interest as the candidate search results, the plurality of points of interest being determined based on a location based search for proximate points of interest to the location associated with the device.

14. The computer program product of claim 10, further comprising a fifth executable portion for receiving a selection of an action to be performed with respect to the particular point of interest.

15. The computer program product of claim 9, further comprising a fourth executable portion for pre-fetching a subset of information corresponding to the location associated with the device.

16. An apparatus comprising a processing element configured to:
receive indications of an image including an object;
receive location information indicative of a location associated with a device providing the indications of the image; and
enable performance of a visual search based on the location information and features of the image to identify candidate search results by comparing the image to source images stored in association with a location within a predetermined distance from the location associated with the device.

17. The apparatus of claim 16, wherein the processing element is further configured to receive an input making an association between a particular point of interest and the image in response to the identified candidate search results.

18. The apparatus of claim 17, wherein the processing element is further configured to query a local database for a matching image to the image, in which the matching image includes the object.

19. The apparatus of claim 18, wherein, if the matching image is found, the processing element is further configured to provide a point of interest associated with the matching image as the particular point of interest and, in response to receiving the input from the user, update a remote database based on the association.

20. The apparatus of claim 18, wherein, if the matching image is not found, the processing element is further configured to provide a plurality of points of interest as the candidate search results, the plurality of points of interest being determined based on a location based search for proximate points of interest to the location associated with the device.

21. The apparatus of claim 20, wherein the processing element is further configured to update a remote database based on the association made responsive to receipt of the input for use in future visual searches.

22. The apparatus of claim 17, wherein the processing element is further configured to receive a selection of an action to be performed with respect to the particular point of interest and launch an external application based on the selected action.

23. The apparatus of claim 16, wherein the processing element is further configured to pre-fetch a subset of information corresponding to the location associated with the device.

24. An apparatus comprising:
means for receiving indications of an image including an object;
means for receiving location information indicative of a location associated with a device providing the indications of the image; and
means for enabling performance of a visual search based on the location information and features of the image to identify candidate search results by comparing the image to source images stored in association with a location within a predetermined distance from the location associated with the device.

25. The apparatus of claim 24, further comprising means for receiving an input making an association between a particular point of interest and the image in response to the identified candidate search results.
